(19) United States
(12) Patent Application Publication
(10) Pub. No.: US 2022/0055748 A1
(43) Pub. Date: Feb. 24, 2022

(54) OBSTACLE AVOIDANCE METHOD AND APPARATUS FOR UNMANNED AERIAL VEHICLE LANDING, AND UNMANNED AERIAL VEHILCE

(71) Applicant: AUTEL ROBOTICS CO., LTD., Shenzhen (CN)

(72) Inventor: Xin Zheng, Shenzhen (CN)

(21) Appl. No.: 17/352,721

(22) Filed: Jun. 21, 2021

Related U.S. Application Data
(63) Continuation of application No. PCT/CN2019/126715, filed on Dec. 19, 2019.

(30) Foreign Application Priority Data
Dec. 20, 2018 (CN) 201811563918.1

(51) Int. Cl. B64C 39/02; G05D 1/10

(52) U.S. Cl. CPC B64C 39/024; B64C 2201/18; B64C 2201/027; G05D 1/106

(57) ABSTRACT

Embodiments of the present invention relate to the field of unmanned aerial vehicle (UAV) control technologies, and in particular, to an obstacle avoidance method and apparatus for UAV landing and a UAV. The obstacle avoidance method for UAV landing includes: obtaining a point cloud distribution map of a to-be-landed zone; determining a safe zone in the to-be-landed zone according to the point cloud distribution map; determining a target position in the safe zone; and controlling the UAV to move to the target position, to enable the UAV to be away from an obstacle in the to-be-landed zone. According to the foregoing manner, the embodiments of the present invention may avoid an obstacle in the to-be-landed zone and reduce a risk of crashing of the UAV.

### CROSS REFERENCE

This application is a continuation of International Application No. PCT/CN2019/126715, filed on Dec. 19, 2019, which claims priority to Chinese Patent Application No. 2018115639181 filed on Dec. 20, 2018, which is incorporated herein by reference in its entirety.

### BACKGROUND

### Technical Field

Embodiments of the present invention relate to the field of unmanned aerial vehicle (UAV) control technologies, and in particular, to an obstacle avoidance method and apparatus for UAV landing and a UAV.

### Related Art

UAV is a drone operated by a radio remote control device or a built-in program control apparatus. With the development of UAV-related technologies and complex changes of UAV application scenarios, increasingly more safety problems occur in a flight process of the UAV. Therefore, the UAV is provided with an autonomous landing protection technology, to prevent the UAV from crashing when landing in an unknown environment.

Currently, according to the autonomous landing protection technology provided for the UAV, after it is detected that there is a risky zone in a to-be-landed zone, the UAV can only fly off or hover above the to-be-landed zone with a risky zone, rather than avoid the risky zone in the to-be-landed zone. As a result, the UAV with a low battery is prone to crashing after the battery runs out.

### SUMMARY

Embodiments of the present invention are intended to provide an obstacle avoidance method and apparatus for unmanned aerial vehicle (UAV) landing and a UAV, to avoid an obstacle in a to-be-landed zone and reduce a risk of crashing of the UAV.

To resolve the foregoing technical problem, a technical solution adopted in the embodiments of the present invention is as follows: an obstacle avoidance method for UAV landing is provided, including:

obtaining a point cloud distribution map of a to-be-landed zone;

determining a safe zone in the to-be-landed zone according to the point cloud distribution map;

determining a target position in the safe zone; and

controlling the UAV to move to the target position, to enable the UAV to be away from an obstacle in the to-be-landed zone.

Optionally, the obtaining a point cloud distribution map of a to-be-landed zone includes:

obtaining the point cloud distribution map of the to-be-landed zone through a depth sensor of the UAV.

Optionally, the obtaining the point cloud distribution map of the to-be-landed zone through a depth sensor of the UAV includes:

obtaining point cloud data of the to-be-landed zone through the depth sensor; and

projecting the point cloud data to a two-dimensional plane to obtain the point cloud distribution map.

Optionally, the determining a target position in the safe zone includes:

determining a center of gravity position of the safe zone; and

determining the center of gravity position of the safe zone as the target position.

Optionally, the determining a center of gravity position of the safe zone includes:

extracting coordinates of each point cloud in the safe zone; and

determining, according to the coordinates of each point cloud, the center of gravity position of the safe zone as:

$$X = \frac{{\sum }_{i = 1}^{n} X i}{n} and Y = \frac{{\sum }_{i = 1}^{n} Yi}{n} ,$$

n being a total quantity of point clouds in the safe zone, Xi being a horizontal coordinate of an i^{th} point cloud in the safe zone, Yi being a vertical coordinate of the i^{th} point cloud in the safe zone, X being a horizontal coordinate of the center of gravity position and Y being a vertical coordinate of the center of gravity position.

Optionally, the controlling the UAV to move to the target position includes:

determining a direction in which the target position is located as a first target direction; and

controlling the UAV to move in the first target direction to the target position.

Optionally, before the controlling the UAV to move in the first target direction to the target position, the method further includes:

determining whether there is an obstacle in the first target direction, and controlling the UAV to move in the first target direction to the target position if there is no obstacle.

Optionally, whether there is an obstacle in the first target direction is determined through a perception sensor.

Optionally, the perception sensor is a one-way perception sensor, and the method further includes:

controlling a perception direction of the one-way perception sensor to be consistent with the first target direction.

Optionally, before the controlling the UAV to move to the target position, the method further includes:

determining a center position of the to-be-landed zone; and

determining whether the target position is consistent with the center position of the to-be-landed zone, and redetermining a target position if the target position is consistent with the center position of the to-be-landed zone.

Optionally, the redetermining a target position includes:

determining a direction in which there is no obstacle in the to-be-landed zone as a second target direction; and

determining a target position in the safe zone after controlling the UAV to move in the second target direction by a preset distance.

Optionally, after the controlling the UAV to move to the target position, the method further includes:

determining whether there is a risky zone in a to-be-landed zone centered around the target position, and controlling the UAV to land if there is no risky zone; or determining a target position in the to-be-landed zone centered around the target position if there is a risky zone.

Optionally, the method further includes:

determining whether a quantity of times of determining a target position in the to-be-landed zone centered around the target position exceeds a first preset threshold, and controlling the UAV to issue a warning and/or controlling the UAV to stop landing if the first preset threshold is exceeded.

Optionally, before the determining a target position in the safe zone, the method further includes:

determining a ratio R1 of a quantity of point clouds in the safe zone to a quantity of point clouds in the to-be-landed zone; and

determining whether R1 is greater than a second preset threshold, and determining a target position in the safe zone if R1 is greater than the second preset threshold.

To resolve the foregoing technical problem, another technical solution adopted in the embodiments of the present invention is as follows: an obstacle avoidance apparatus for UAV landing is provided, including:

an obtaining module, configured to obtain a point cloud distribution map of a to-be-landed zone;

a determining module, configured to determine a safe zone in the to-be-landed zone according to the point cloud distribution map; and

determine a target position in the safe zone; and

a control module, configured to control the UAV to move to the target position, to enable the UAV to be away from an obstacle in the to-be-landed zone.

Optionally, the obtaining module obtains the point cloud distribution map of the to-be-landed zone through a depth sensor of the UAV.

Optionally, the obtaining module is specifically configured to:

obtain point cloud data of the to-be-landed zone through the depth sensor; and

project the point cloud data to a two-dimensional plane to obtain the point cloud distribution map.

Optionally, the determining module is configured to:

determine a center of gravity position of the safe zone; and

determine the center of gravity position of the safe zone as the target position.

Optionally, the determining module is further configured to:

extract coordinates of each point cloud in the safe zone; and

determine, according to the coordinates of each point cloud, the center of gravity position of the safe zone as:

$$X = \frac{{\sum }_{i = 1}^{n} X i}{n} and Y = \frac{{\sum }_{i = 1}^{n} Yi}{n} ,$$

n being a total quantity of point clouds in the safe zone, Xi being a horizontal coordinate of an i^{th} point cloud in the safe zone, Yi being a vertical coordinate of the i^{th} point cloud in the safe zone, X being a horizontal coordinate of the center of gravity position and Y being a vertical coordinate of the center of gravity position.

Optionally, the control module is configured to:

determine a direction in which the target position is located as a first target direction; and

control the UAV to move in the first target direction to the target position.

Optionally, the control module is further configured to:

determine whether there is an obstacle in the first target direction, and control the UAV to move in the first target direction to the target position if there is no obstacle.

Optionally, the control module determines whether there is an obstacle in the first target direction through a perception sensor.

Optionally, the perception sensor is a one-way perception sensor, and the control module is further configured to:

control a perception direction of the one-way perception sensor to be consistent with the first target direction.

Optionally, the determining module is further configured to:

determine a center position of the to-be-landed zone; and

determine whether the target position is consistent with the center position of the to-be-landed zone, and redetermine a target position if the target position is consistent with the center position of the to-be-landed zone.

Optionally, the determining module is further configured to:

determine a direction in which there is no obstacle in the to-be-landed zone as a second target direction; and

determine a target position in the safe zone after controlling the UAV to move in the second target direction by a preset distance.

Optionally, the control module is further configured to:

determine whether there is a risky zone in a to-be-landed zone centered around the target position, and control the UAV to land if there is no risky zone; or determine a target position in the to-be-landed zone centered around the target position if there is a risky zone.

Optionally, the control module is further configured to:

determine whether a quantity of times of determining a target position in the to-be-landed zone centered around the target position exceeds a first preset threshold, and control the UAV to issue a warning and/or control the UAV to stop landing if the first preset threshold is exceeded.

Optionally, the determining module is further configured to:

determine a ratio R1 of a quantity of point clouds in the safe zone to a quantity of point clouds in the to-be-landed zone; and

determine whether R1 is greater than a second preset threshold, and determine a target position in the safe zone if R1 is greater than the second preset threshold.

To resolve the foregoing technical problem, another technical solution adopted in the embodiments of the present invention is as follows: a UAV is provided, including:

a body;

arms connected to the body;

power apparatuses disposed on the arms;

at least one processor disposed in the body; and

a memory communicatively connected to the at least one processor, the memory storing instructions executable by the at least one processor, the instructions being executed by the at least one processor, to enable the at least one processor to perform the obstacle avoidance method for UAV landing described above.

To resolve the foregoing technical problem, another technical solution adopted in the embodiments of the present invention is as follows: a non-volatile computer-readable storage medium is provided, storing computer-executable instructions used for causing a UAV to perform the obstacle avoidance method for UAV landing described above.

Beneficial effects of the embodiments of the present invention are as follows: different from the related art, the embodiments of the present invention provide an obstacle avoidance method and apparatus for UAV landing and a UAV. In the obstacle avoidance method for UAV landing, a target position is determined in a safe zone of a to-be-landed zone and a UAV is controlled to move to the target position, to enable the UAV to move toward the safe zone of the to-be-landed zone. Since the safe zone is a zone in which there is no obstacle, when the UAV moves toward the safe zone, an obstacle is avoided, and a risk of crashing of the UAV is reduced.

### BRIEF DESCRIPTION OF THE DRAWINGS

One or more embodiments are exemplarily described with reference to the corresponding figures in the accompanying drawings, and the descriptions are not to be construed as limiting the embodiments. Components in the accompanying drawings that have same reference numerals are represented as similar components, and unless otherwise particularly stated, the figures in the accompanying drawings are not drawn to scale.

FIG. 1 is a schematic structural diagram of an unmanned aerial vehicle (UAV) according to an embodiment of the present invention.

FIG. 2 is a schematic flowchart of an obstacle avoidance method for UAV landing according to an embodiment of the present invention.

FIG. 3 is a schematic flowchart of step S400 in the method shown in FIG. 2.

FIG. 4 is a schematic flowchart of step S800 in the method shown in FIG. 2.

FIG. 5 is a schematic flowchart of an obstacle avoidance method for UAV landing according to another embodiment of the present invention.

FIG. 6 is a schematic flowchart of an obstacle avoidance method for UAV landing according to another embodiment of the present invention.

FIG. 7 is a schematic flowchart of an obstacle avoidance method for UAV landing according to another embodiment of the present invention.

FIG. 8 is a schematic structural diagram of an obstacle avoidance apparatus for UAV landing according to an embodiment of the present invention.

FIG. 9 is a schematic structural diagram of hardware of a UAV according to an embodiment of the present invention.

### DETAILED DESCRIPTION

To make the objectives, technical solutions, and advantages of the embodiments of the present invention clearer, the following clearly and completely describes the technical solutions in the embodiments of the present invention with reference to the accompanying drawings in the embodiments of the present invention. Apparently, the described embodiments are merely some embodiments of the present invention rather than all of the embodiments. It should be understood that the specific embodiments described herein are merely used for explaining the present invention but are not intended to limit the present invention. All other embodiments obtained by a person of ordinary skill in the art based on the embodiments of the present invention without creative efforts shall fall within the protection scope of the present invention.

It should be noted that, when a component is expressed as “being fixed to” another component, the component may be directly on the another component, or one or more intermediate components may exist between the component and the another component. When one component is expressed as “being connected to” another component, the component may be directly connected to the another component, or one or more intermediate components may exist between the component and the another component. The terms “vertical”, “horizontal”, “left”, “right”, and similar expressions used in this specification are merely used for an illustrative purpose.

In addition, technical features involved in the embodiments of the present invention described below may be combined with each other provided that there is no conflict between each other.

The present invention provides an obstacle avoidance method and apparatus for unmanned aerial vehicle (UAV) landing. The method and apparatus are applicable to a UAV, to enable the UAV to determine a target position in a safe zone of a to-be-landed zone and move to the target position when detecting that there is a risky zone in the to-be-landed zone, thereby avoiding an obstacle in the to-be-landed zone and reducing a risk of crashing. The risky zone refers to a zone in which there is an obstacle. The obstacle includes: a slope, a water surface, a shrubbery, a protruding foreign body, or an edge-vacant zone of a surface-smooth zone such as a rooftop, a cliff or a deep ditch. The target position refers to a position to which the UAV is about to move.

The UAV in the present invention may be any suitable type of high-altitude UAV or low-altitude UAV, including a fixed-wing UAV, a rotary-wing UAV, a para-wing UAV, a flapping-wing UAV, or the like.

The present invention will be described below in detail by using specific embodiments.

### Embodiment 1

FIG. 1 shows a UAV 100 according to an embodiment of the present invention, including a body 10, arms 20, power apparatuses 30, a depth sensor 40, landing gears 50 and a flight control system (not shown in the figure). The arms 20, the depth sensor 40 and the landing gears 50 are all connected to the body 10. The flight control system is disposed in the body 10. The power apparatuses 30 are disposed on the arms 20. The power apparatuses 30, the depth sensor 40 and the landing gears 50 are all communicatively connected to the flight control system, so that the flight control system may control flight of the UAV 100 through the power apparatuses 30, obtain a point cloud distribution map of a to-be-landed zone of the UAV 100 through the depth sensor 40 and control the landing gears 50 to come into contact with the ground.

Preferably, there are four arms 20, which are evenly distributed around the body 10 to carry the power apparatuses 30.

The power apparatus 30 includes a motor and a propeller connected to a shaft of the motor. The motor can drive the propeller to rotate to provide an elevating force for the UAV 100 to fly, and change a flight direction of the UAV 100 by changing a rotation speed and direction of the propeller. When the power apparatus 30 is communicatively connected to the flight control system, the flight control system may control the flight of the UAV 100 by controlling the motor.

The power apparatus 30 is disposed at one end of the arm 20 that is not connected to the body 10, and connected to the arm 20 through the motor.

Preferably, the four arms 20 of the UAV 100 each have a power apparatus 30 to allow the UAV 100 to fly smoothly.

The depth sensor 40 is disposed at the bottom of the body 10 to acquire point cloud data of the to-be-landed zone of the UAV 100. In the point cloud data, each point cloud includes three-dimensional coordinates, and some point clouds may include color information or reflection intensity information. A distance between the depth sensor 40 and an object in the to-be-landed zone may be obtained through the point cloud data. When the depth sensor 40 is communicatively connected to the flight control system, the flight control system may obtain the point cloud data of the to-be-landed zone of the UAV 100 from the depth sensor 40, and project the point cloud data to a two-dimensional plane to obtain the point cloud distribution map of the to-be-landed zone.

Further, the depth sensor 40 is disposed at the bottom of the body 10 through a pan tilt platform to enable the depth sensor 40 to acquire the point cloud data of the to-be-landed zone omni-directionally.

The depth sensor 40 includes, but is not limited to: a binocular camera, a time of flight (TOF) camera, a structured light camera and a lidar.

The landing gears 50 are disposed on two opponent sides of the bottom of the body 10 and connected to the body 10 through driving apparatuses. The landing gears 50 may be stretched and retracted under the driving of the driving apparatuses. When the UAV 100 comes into contact with the ground, the driving apparatuses control the landing gears 50 to stretch, to enable the UAV 100 to come into contact with the ground through the landing gears 50. During the flight of the UAV 100, the driving apparatuses control the landing gears 50 to retract, to prevent the landing gears 50 from affecting the flight of the UAV 100. When the landing gears 50 are communicatively connected to the flight control system, the flight control system may control the driving apparatuses to control the landing gears 50 to come into contact with the ground.

It may be understood that, when landed on the ground, the UAV 100 comes into contact with the ground only through the landing gears 50. In this case, an actual landing zone of the UAV 100 is a zone bounded by the landing gears 50 in contact with the ground.

When the UAV 100 comes into contact with the ground through the landing gears 50, a projection of the body of the UAV 100 on the ground forms a projection zone, a center of the projection zone overlapping with a center of the actual landing zone, and the projection zone being greater than the actual landing zone. The projection zone includes a motion range of the propellers and represents a minimum zone in which the UAV 100 can move normally.

Further, a perception sensor (not shown in the figure) is further disposed in the body 10, to determine whether there is an obstacle in a flight direction of the UAV 100.

The perception sensor is communicatively connected to the flight control system, so that the flight control system may control the flight direction of the UAV 100 according to a determination result of the perception sensor. For example, if the perception sensor determines that there is an obstacle in the flight direction of the UAV 100, the flight control system controls the UAV 100 to change the flight direction.

The perception sensor includes a one-way perception sensor or a multi-way perception sensor.

When the perception sensor is a one-way perception sensor, the one-way perception sensor can determine whether there is an obstacle in only one direction. Therefore, when the one-way perception sensor is disposed in the body 10, a perception direction of the one-way perception sensor is consistent with the flight direction of the UAV 100. That is, the flight direction of the UAV 100 is the perception direction of the one-way perception sensor. When the UAV 100 changes the flight direction, the perception direction of the one-way perception sensor changes along with the change of the flight direction of the UAV 100, to enable the one-way perception sensor to always determine whether there is an obstacle in the flight direction of the UAV 100.

When the perception sensor is a multi-way perception sensor, the multi-way perception sensor may determine whether there is an obstacle in any direction of the UAV 100. Therefore, when the multi-way perception sensor is disposed in the body 10, a perception direction of the multi-way perception sensor may not be changed along with the change of the flight direction of the UAV 100.

The flight control system is communicatively connected to the power apparatuses 30, the depth sensor 40, the landing gears 50 and the perception sensor through a wired connection or a wireless connection. The wireless connection includes, but is not limited to: Wi-Fi, Bluetooth, Zigbee and the like.

The flight control system is configured to perform the obstacle avoidance method for UAV landing in the present invention, to enable the UAV 100 to avoid an obstacle in the to-be-landed zone and reduce a risk of crashing of the UAV 100.

Specifically, when the UAV 100 prepares to land, the flight control system obtains the point cloud distribution map of the to-be-landed zone through the depth sensor 40.

The to-be-landed zone is a zone in which the UAV 100 prepares to land, the UAV 100 being located at a center of the to-be-landed zone.

The point cloud distribution map is a schematic diagram that can reflect a point cloud distribution status of the to-be-landed zone.

In an embodiment of the present invention, the obtaining, by the flight control system, the point cloud distribution map of the to-be-landed zone through the depth sensor 40 specifically includes: obtaining, by the flight control system, the point cloud data of the to-be-landed zone through the depth sensor 40, and projecting the obtained point cloud data to a two-dimensional plane to obtain the point cloud distribution map.

Certainly, in some alternative embodiments, the obtaining, by the flight control system, the point cloud distribution map of the to-be-landed zone through the depth sensor 40 may alternatively include: obtaining, by the flight control system, a depth map of the to-be-landed zone through the depth sensor 40, and obtaining the point cloud distribution map according to the obtained depth map.

Further, after obtaining the point cloud distribution map of the to-be-landed zone, the flight control system determines a safe zone in the to-be-landed zone according to the point cloud distribution map.

The safe zone is a zone in which there is no obstacle in the to-be-landed zone, that is, a zone other than a risky zone in which there is an obstacle in the to-be-landed zone.

The flight control system may determine the safe zone in the to-be-landed zone according to the point cloud distribution map through a plane detection method or a vacant zone detection method.

Specifically, when the safe zone in the to-be-landed zone is determined through the plane detection method, after a plane is determined by extracting feature points in the point cloud distribution map, a zone in which point clouds are all located in the plane is determined as the safe zone.

When the safe zone in the to-be-landed zone is determined through the vacant zone detection method, a detection zone in the point cloud distribution map of the to-be-landed zone is divided into at least two specified zones, then a quantity of point clouds in each specified zone is detected, and a specified zone in which a quantity of point clouds is not less than a threshold is determined as the safe zone.

Certainly, in some embodiments, the safe zone in the to-be-landed zone may be alternatively determined by combining the plane detection method and the vacant zone detection method, to improve the accuracy of determining the safe zone.

Further, after the safe zone in the to-be-landed zone is determined, to prevent the UAV 100 from crashing after landing due to an excessively small safe zone, the flight control system determines a ratio R1 of a quantity of point clouds in the safe zone to a quantity of point clouds in the to-be-landed zone, and determines whether the ratio R1 is greater than a second preset threshold. If the ratio R1 is greater than the second preset threshold, it indicates that the safe zone is large enough to meet a landing requirement of the UAV 100. In this case, a target position is determined in the safe zone.

The second preset threshold is a preset fixed value, which ranges from 10% to 30%.

Certainly, in some alternative implementations, the second preset threshold is related to an area of a projection zone of the UAV 100, and a ratio of the area of the projection zone of the UAV 100 to an area of the to-be-landed zone may be determined as the second preset threshold.

In an embodiment of the present invention, the determining a target position in the safe zone specifically includes: determining, by the flight control system, a center of gravity position of the safe zone, and determining the determined center of gravity position as the target position.

A center of gravity of the safe zone is a “center of mass” of all point clouds in the safe zone. The center of gravity position of the safe zone may be determined according to an average value of coordinates of all the point clouds in the safe zone.

When determining the center of gravity position of the safe zone, the flight control system extracts coordinates of each point cloud in the safe zone, and then determines the center of gravity position of the safe zone according to the coordinates of each point cloud.

The center of gravity position of the safe zone is as follows:

$$X = \frac{{\sum }_{i = 1}^{n} X i}{n} and Y = \frac{{\sum }_{i = 1}^{n} Yi}{n} ,$$

n being a total quantity of point clouds in the safe zone, Xi being a horizontal coordinate of an i^{th} point cloud in the safe zone, Yi being a vertical coordinate of the i^{th} point cloud in the safe zone, X being a horizontal coordinate of the center of gravity position and Y being a vertical coordinate of the center of gravity position.

For example, the total quantity of point clouds in the safe zone is 3, coordinates of the first point cloud are (X1, Y1), coordinates of the second point cloud are (X2, Y2) and coordinates of the third point cloud are (X3, Y3). In this case, the flight control system extracts coordinates of each point cloud in the safe zone, that is, extracts the coordinates (X1, Y1) of the first point cloud, the coordinates (X2, Y2) of the second point cloud and the coordinates (X3, Y3) of the third point cloud respectively. The flight control system then calculates the center of gravity position of the safe zone according to the coordinates (X1, Y1) of the first point cloud, the coordinates (X2, Y2) of the second point cloud and the coordinates (X3, Y3) of the third point cloud that are extracted. A horizontal coordinate of the center of gravity position of the safe zone is

$$X = \frac{X 1 + X 2 + X 3}{3} ,$$

and a vertical coordinate of the center of gravity position of the safe zone is

$$Y = \frac{Y 1 + Y 2 + Y 3}{3} .$$

Further, when an obstacle in the to-be-landed zone is symmetric relative to a center of the UAV 100, the determined center of gravity position of the safe zone is consistent with a center position of the to-be-landed zone, and the UAV cannot avoid the obstacle. Therefore, to prevent the center of gravity position of the safe zone from being consistent with the center position of the to-be-landed zone, after the target position is determined, the flight control system further needs to determine the center position of the to-be-landed zone, and determine whether the target position is consistent with the center position of the to-be-landed zone. If the target position is inconsistent with the center position of the to-be-landed zone, the flight control system controls the UAV 100 to move to the target position. If the target position is consistent with the center position of the to-be-landed zone, the flight control system needs to redetermine a target position.

In an embodiment of the present invention, the controlling the UAV 100 to move to the target position specifically includes: controlling, by the flight control system after determining a direction in which the target position is located as a first target direction, the UAV 100 to move in the first target direction to the target position.

To prevent the UAV 100 from colliding with an obstacle when moving to the target position, before controlling the UAV 100 to move in the first target direction to the target position, the flight control system determines whether there is an obstacle in the first target direction through the perception sensor, and controls the UAV 100 to move in the first target direction to the target position if there is no obstacle.

When the perception sensor is a one-way perception sensor, the controlling, by the flight control system, a perception direction of the one-way perception sensor to be consistent with the first target direction specifically includes: controlling, by the flight control system, the flight direction of the UAV 100 to be consistent with the first target direction. Since the perception direction of the one-way perception sensor is consistent with the flight direction, the perception direction of the one-way perception sensor may be controlled to be consistent with the first target direction by controlling the flight direction of the UAV 100 to be consistent with the first target direction.

In an embodiment of the present invention, the redetermining a target position includes: determining, by the flight control system, a direction in which there is no obstacle in the to-be-landed zone as a second target direction, and determining a target position in the safe zone after controlling the UAV 100 to move in the second target direction by a preset distance.

The flight control system determines the second target direction through the perception sensor.

The preset distance is related to the second target direction and a size of the to-be-landed zone. If the second target direction is a width direction of the to-be-landed zone, the preset distance is a half width of the to-be-landed zone. If the second target direction is a length direction of the to-be-landed zone, the preset distance is a half width of the to-be-landed zone. In this way, it is ensured that the UAV 100 can leave the to-be-landed zone after moving in the second target direction by the preset distance, and determine a target position in a new safe zone.

Further, after the UAV moves to the target position, the flight control system determines whether there is a risky zone in a to-be-landed zone centered around the target position, and determines a target position in the to-be-landed zone centered around the target position if there is a risky zone; or controls the UAV to land if there is no risky zone.

In an embodiment of the present invention, if it is determined that a quantity of times of determining a target position in the to-be-landed zone centered around the target position exceeds a first preset threshold, the UAV is controlled to issue a warning and/or the UAV is controlled to stop landing.

Preferably, the first preset threshold is a preset fixed value, which ranges from 3 to 5.

In this embodiment of the present invention, a target position is determined in a safe zone of a to-be-landed zone and a UAV is controlled to move to the target position, to enable the UAV to move toward the safe zone of the to-be-landed zone. Since the safe zone is a zone in which there is no obstacle, when the UAV moves toward the safe zone, an obstacle is avoided, and a risk of crashing of the UAV is reduced.

### Embodiment 2

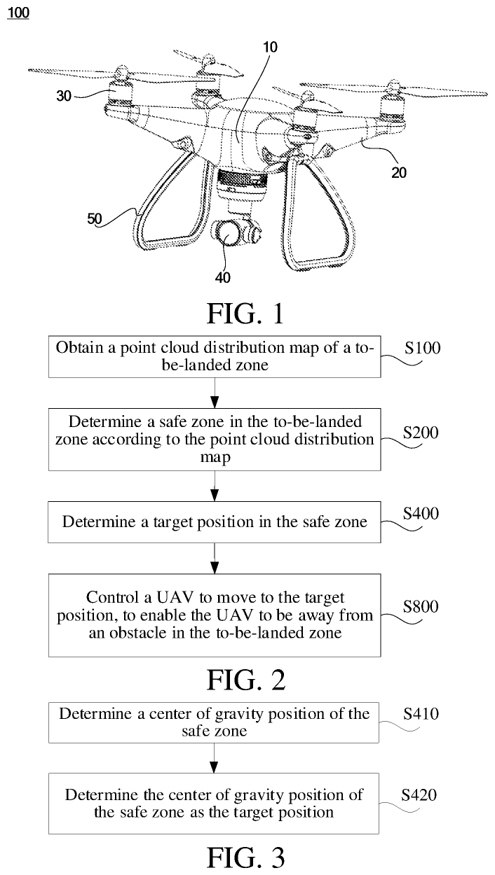

FIG. 2 is a schematic flowchart of an obstacle avoidance method for UAV landing according to an embodiment of the present invention, which is applicable to a UAV. The UAV is the UAV 100 in the foregoing embodiment. The method provided in this embodiment of the present invention is performed by the flight control system to avoid an obstacle in a to-be-landed zone and reduce a risk of crashing of the UAV. The obstacle avoidance method for UAV landing includes the following steps:

S100: Obtain a point cloud distribution map of a to-be-landed zone.

The “to-be-landed zone” is a zone in which the UAV prepares to land, the UAV being located at a center of the to-be-landed zone.

The “point cloud distribution map” is a schematic diagram that can reflect a point cloud distribution status of the to-be-landed zone.

In an embodiment of the present invention, the obtaining a point cloud distribution map of a to-be-landed zone specifically includes: obtaining the point cloud distribution map of the to-be-landed zone through a depth sensor of the UAV.

The depth sensor includes, but is not limited to: a binocular camera, a TOF camera, a structured light camera and a lidar.

The depth sensor is configured to acquire point cloud data of the to-be-landed zone. Each piece of point cloud data includes three-dimensional coordinates, and some data may include color information or reflection intensity information. A distance between the depth sensor and an object in the to-be-landed zone may be obtained through the point cloud data.

In this case, the obtaining the point cloud distribution map of the to-be-landed zone through a depth sensor specifically includes: obtaining point cloud data of the to-be-landed zone through the depth sensor, and projecting the point cloud data to a two-dimensional plane to obtain the point cloud distribution map.

S200: Determine a safe zone in the to-be-landed zone according to the point cloud distribution map.

The to-be-landed zone includes a safe zone and a risky zone. The risky zone refers to a zone in which there is an obstacle. The obstacle includes: a slope, a water surface, a shrubbery, a protruding foreign body, or an edge-vacant zone of a surface-smooth zone such as a rooftop, a cliff or a deep ditch. The safe zone refers to a zone in which there is no obstacle, that is, a zone other than the risky zone in which there is an obstacle in the to-be-landed zone.

In an embodiment of the present invention, the safe zone in the to-be-landed zone may be determined according to the point cloud distribution map through a plane detection method or a vacant zone detection method.

Specifically, when the safe zone in the to-be-landed zone is determined through the plane detection method, after a plane is determined by extracting feature points in the point cloud distribution map, a zone in which point clouds are all located in the plane is determined as the safe zone.

When the safe zone in the to-be-landed zone is determined through the vacant zone detection method, a detection zone in the point cloud distribution map of the to-be-landed zone is divided into at least two specified zones, then a quantity of point clouds in each specified zone is detected, and a specified zone in which a quantity of point clouds is not less than a threshold is determined as the safe zone.

Certainly, in some embodiments, the safe zone in the to-be-landed zone may be alternatively determined by combining the plane detection method and the vacant zone detection method, to improve the accuracy of determining the safe zone.

S400: Determine a target position in the safe zone.

The “target position” is a position that enables the UAV to be away from an obstacle in the safe zone, that is, a position to which the UAV is about to move.

Referring to FIG. 3, in an embodiment of the present invention, the determining a target position in the safe zone specifically includes the following steps:

S410: Determine a center of gravity position of the safe zone.

S420: Determine the center of gravity position of the safe zone as the target position.

The determining a center of gravity position of the safe zone specifically includes: extracting coordinates of each point cloud in the safe zone; and determining the center of gravity position of the safe zone according to the coordinates of each point cloud. The center of gravity position of the safe zone is as follows:

$$X = \frac{{\sum }_{i = 1}^{n} X i}{n} and Y = \frac{{\sum }_{i = 1}^{n} Yi}{n} ,$$

n being a total quantity of point clouds in the safe zone, Xi being a horizontal coordinate of an i^{th} point cloud in the safe zone, Yi being a vertical coordinate of the i^{th} point cloud in the safe zone, X being a horizontal coordinate of the center of gravity position and Y being a vertical coordinate of the center of gravity position.

For example, the total quantity of point clouds in the safe zone is 3, coordinates of the first point cloud are (X1, Y1), coordinates of the second point cloud are (X2, Y2) and coordinates of the third point cloud are (X3, Y3). In this case, the flight control system extracts the coordinates of each point cloud in the safe zone, that is, extracts the coordinates (X1, Y1) of the first point cloud, the coordinates (X2, Y2) of the second point cloud and the coordinates (X3, Y3) of the third point cloud respectively. The flight control system then calculates the center of gravity position of the safe zone according to the coordinates (X1, Y1) of the first point cloud, the coordinates (X2, Y2) of the second point cloud and the coordinates (X3, Y3) of the third point cloud that are extracted. A horizontal coordinate of the center of gravity position of the safe zone is

$$X = \frac{X 1 + X 2 + X 3}{3} ,$$

and a vertical coordinate of the center of gravity position of the safe zone is

$$Y = \frac{Y 1 + Y 2 + Y 3}{3} .$$

Since the safe zone is a zone other than the risky zone in the to-be-landed zone, in a case that an obstacle is not symmetric relative to a center position of the to-be-landed zone, the center of gravity position of the safe zone deviates from the center position of the to-be-landed zone. As a result, when the center of gravity position of the safe zone is determined as the target position, the UAV moving to the target position may be enabled to be away from the obstacle.

S800: Control the UAV to move to the target position, to enable the UAV to be away from an obstacle in the to-be-landed zone.

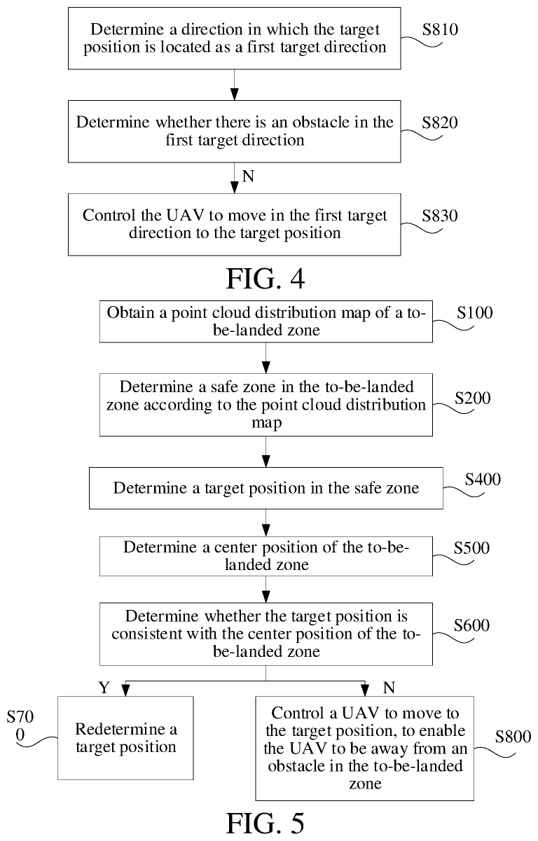

Referring to FIG. 4, in an embodiment of the present invention, the controlling the UAV to move to the target position specifically includes the following steps:

S810: Determine a direction in which the target position is located as a first target direction.

S820: Determine whether there is an obstacle in the first target direction.

S830: Control the UAV to move in the first target direction to the target position if there is no obstacle.

Whether there is an obstacle in the first target direction is determined through a perception sensor.

When the perception sensor is a one-way perception sensor, a perception direction of the one-way perception sensor is controlled to be consistent with the first target direction. Specifically, a flight direction of the UAV is controlled to be consistent with the first target direction. Since the perception direction of the one-way perception sensor is consistent with the flight direction, the perception direction of the one-way perception sensor may be controlled to be consistent with the first target direction by controlling the flight direction of the UAV to be consistent with the first target direction.

Referring to FIG. 5, when an obstacle in the to-be-landed zone is symmetric relative to a center of the UAV, the determined center of gravity position of the safe zone is consistent with the center position of the to-be-landed zone, and the UAV cannot avoid the obstacle. Therefore, to prevent the center of gravity position of the safe zone from being consistent with the center position of the to-be-landed zone, in another embodiment of the present invention, before step S800, the method further includes the following steps:

S500: Determine the center position of the to-be-landed zone.

S600: Determine whether the target position is consistent with the center position of the to-be-landed zone, and perform step S700 if the target position is consistent with the center position of the to-be-landed zone; or perform step S800 if the target position is inconsistent with the center position of the to-be-landed zone.

S700: Redetermine a target position.

The redetermining a target position includes: determining a direction in which there is no obstacle in the to-be-landed zone as a second target direction; and determining a target position in the safe zone after controlling the UAV to move in the second target direction by a preset distance.

The second target direction may be determined through the perception sensor.

The preset distance is related to the second target direction and a size of the to-be-landed zone. If the second target direction is a width direction of the to-be-landed zone, the preset distance is a half width of the to-be-landed zone. If the second target direction is a length direction of the to-be-landed zone, the preset distance is a half width of the to-be-landed zone.

In this way, it is ensured that the UAV 100 can leave the to-be-landed zone after moving in the second target direction by the preset distance, and determine a target position in a new safe zone.

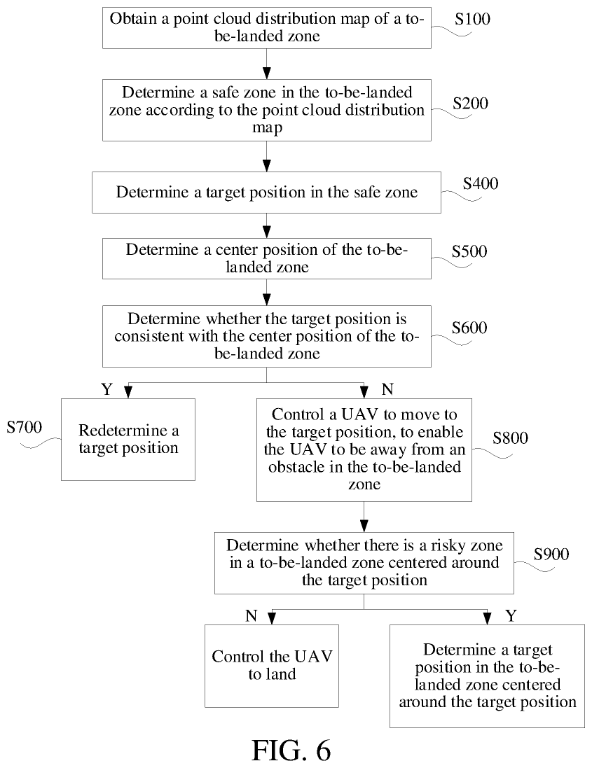

Referring to FIG. 6, in another embodiment of the present invention, after step S800, the method further includes the following step:

S900: Determine whether there is a risky zone in a to-be-landed zone centered around the target position, and control the UAV to land if there is no risky zone; or determine a target position in the to-be-landed zone centered around the target position if there is a risky zone.

Whether there is a risky zone in the to-be-landed zone may be determined through a plane detection method or a vacant zone detection method.

When whether there is a risky zone in the to-be-landed zone is determined through the plane detection method, after a plane is determined by extracting feature points in the point cloud distribution map, a zone in which point clouds are all located outside the plane is determined as the risky zone.

When whether there is a risky zone in the to-be-landed zone is determined through the vacant zone detection method, a detection zone in the point cloud distribution map of the to-be-landed zone is divided into at least two specified zones, then a quantity of point clouds in each specified zone is detected, and a specified zone in which a quantity of point clouds is less than a threshold is determined as the risky zone.

Certainly, in some embodiments, the risky zone in the to-be-landed zone may be alternatively determined by combining the plane detection method and the vacant zone detection method, to improve the accuracy of determining the safe zone.

Further, it is determined whether a quantity of times of determining a target position in the to-be-landed zone centered around the target position exceeds a first preset threshold, and the UAV is controlled to issue a warning and/or the UAV is controlled to stop landing if the first preset threshold is exceeded.

Preferably, the first preset threshold is a preset fixed value, which ranges from 3 to 5.

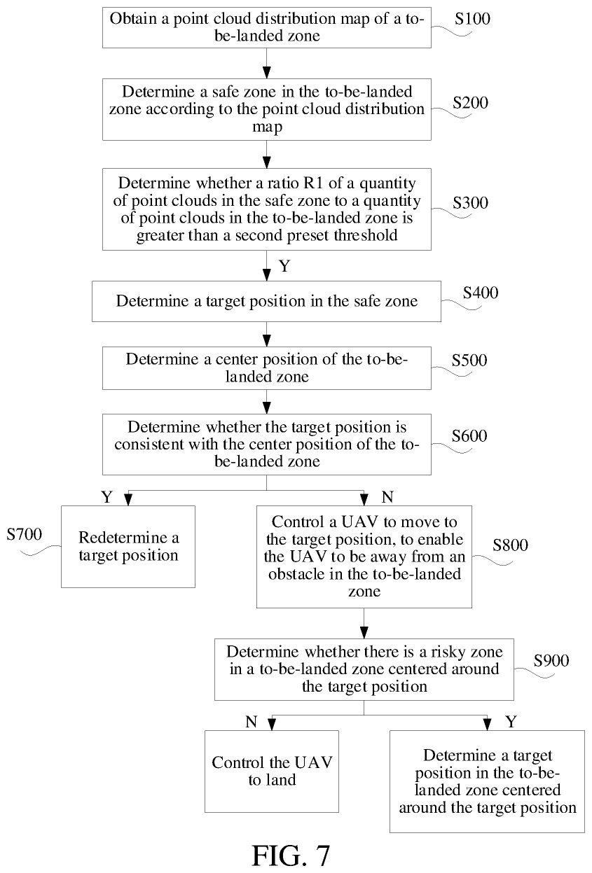

Referring to FIG. 7, in another embodiment of the present invention, to prevent the UAV from crashing after landing due to an excessively small safe zone, before step S400, the method further includes the following step:

S300: Determine whether a ratio R1 of a quantity of point clouds in the safe zone to a quantity of point clouds in the to-be-landed zone is greater than a second preset threshold, and perform step S400 if R1 is greater than the second preset threshold.

The second preset threshold is a preset fixed value, which ranges from 10% to 30%.

Certainly, in some alternative implementations, the second preset threshold is related to an area of a projection zone of the UAV 100, and a ratio of the area of the projection zone of the UAV 100 to an area of the to-be-landed zone may be determined as the second preset threshold.

In this embodiment of the present invention, a target position is determined in a safe zone of a to-be-landed zone and a UAV is controlled to move to the target position, to enable the UAV to move toward the safe zone of the to-be-landed zone. Since the safe zone is a zone in which there is no obstacle, when the UAV moves toward the safe zone, an obstacle is avoided, and a risk of crashing of the UAV is reduced.

### Embodiment 3

The following term “module” may refer to a combination of software and/or hardware implementing a predetermined function. Although the apparatus described in the following embodiments may be implemented by using software, it is also conceivable that the apparatus may be implemented by using hardware, or a combination of software and hardware.

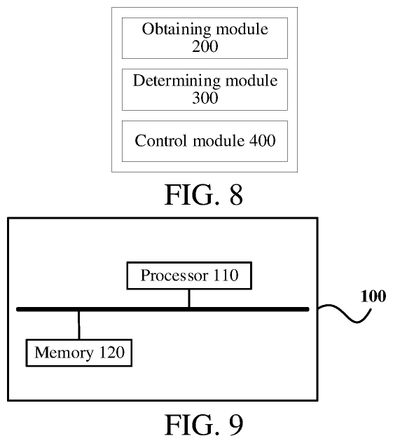

FIG. 8 is an obstacle avoidance apparatus for UAV landing according to an embodiment of the present invention, which is applicable to a UAV. The UAV is the UAV 100 in the foregoing embodiment. Functions of modules of the apparatus provided in this embodiment of the present invention are performed by the flight control system to avoid an obstacle in a to-be-landed zone and reduce a risk of crashing of the UAV. The obstacle avoidance apparatus for UAV landing includes:

an obtaining module 200, configured to obtain a point cloud distribution map of a to-be-landed zone;

a determining module 300, configured to determine a safe zone in the to-be-landed zone according to the point cloud distribution map; and

determine a target position in the safe zone; and

a control module 400, configured to control the UAV to move to the target position, to enable the UAV to be away from an obstacle in the to-be-landed zone.

The obtaining module 200 obtains the point cloud distribution map of the to-be-landed zone through a depth sensor of the UAV.

Further, the obtaining module 200 is specifically configured to:

obtain point cloud data of the to-be-landed zone through the depth sensor; and

project the point cloud data to a two-dimensional plane to obtain the point cloud distribution map.

Further, the determining module 300 is specifically configured to:

determine a center of gravity position of the safe zone; and

determine the center of gravity position of the safe zone as the target position.

Further, the determining module 300 is further configured to:

extract coordinates of each point cloud in the safe zone; and

determine, according to the coordinates of each point cloud, the center of gravity position of the safe zone as:

$$X = \frac{{\sum }_{i = 1}^{n} X i}{n} and Y = \frac{{\sum }_{i = 1}^{n} Yi}{n} ,$$

n being a total quantity of point clouds in the safe zone, Xi being a horizontal coordinate of an i^{th} point cloud in the safe zone, Yi being a vertical coordinate of the i^{th} point cloud in the safe zone, X being a horizontal coordinate of the center of gravity position and Y being a vertical coordinate of the center of gravity position.

Further, the control module 400 is specifically configured to:

determine a direction in which the target position is located as a first target direction; and

control the UAV to move in the first target direction to the target position.

Further, the control module 400 is further configured to:

determine whether there is an obstacle in the first target direction, and control the UAV to move in the first target direction to the target position if there is no obstacle.

Further, the control module 400 determines whether there is an obstacle in the first target direction through a perception sensor.

Further, the perception sensor is a one-way perception sensor, and the control module 400 is further configured to:

control a perception direction of the one-way perception sensor to be consistent with the first target direction.

Further, the determining module 300 is further configured to:

determine a center position of the to-be-landed zone; and

determine whether the target position is consistent with the center position of the to-be-landed zone, and redetermine a target position if the target position is consistent with the center position of the to-be-landed zone.

Further, the determining module 300 is further configured to:

determine a direction in which there is no obstacle in the to-be-landed zone as a second target direction; and

determine a target position in the safe zone after controlling the UAV to move in the second target direction by a preset distance.

Further, the control module 400 is further configured to:

determine whether there is a risky zone in a to-be-landed zone centered around the target position, and control the UAV to land if there is no risky zone; or determine a target position in the to-be-landed zone centered around the target position if there is a risky zone.

Further, the control module 400 is further configured to:

determine whether a quantity of times of determining a target position in the to-be-landed zone centered around the target position exceeds a first preset threshold, and control the UAV to issue a warning and/or control the UAV to stop landing if the first preset threshold is exceeded.

Further, the determining module 300 is further configured to:

determine a ratio R1 of a quantity of point clouds in the safe zone to a quantity of point clouds in the to-be-landed zone; and

determine whether R1 is greater than a second preset threshold, and determine a target position in the safe zone if R1 is greater than the second preset threshold.

Certainly, in some other alternative embodiments, the obtaining module 200 may be a depth sensor to directly obtain the point cloud distribution map of the to-be-landed zone; and the determining module 300 and the control module 400 may be a flight control chip.

The apparatus embodiment and the method embodiment are based on the same concept. Therefore, for the content of the apparatus embodiment, reference may be made to the method embodiment without mutual conflict between content, and details are not described herein again.

In this embodiment of the present invention, a target position is determined in a safe zone of a to-be-landed zone and a UAV is controlled to move to the target position, to enable the UAV to move toward the safe zone of the to-be-landed zone. Since the safe zone is a zone in which there is no obstacle, when the UAV moves toward the safe zone, an obstacle is avoided, and a risk of crashing of the UAV is reduced.

### Embodiment 4

FIG. 9 is a schematic structural diagram of hardware of a UAV according to an embodiment of the present invention. Hardware modules provided in this embodiment of the present invention may be integrated into the flight control system in the foregoing embodiment or may be directly used as the flight control system and disposed in the body 10, so that the UAV 100 can perform the obstacle avoidance method for UAV landing in the foregoing embodiment and implement functions of the modules of the obstacle avoidance apparatus for UAV landing in the foregoing embodiment. The UAV 100 includes:

one or more processors 110 and a memory 120. In FIG. 9, one processor 110 is used as an example.

The processor 110 and the memory 120 may be connected through a bus or in other manners, which are, for example, connected through a bus in FIG. 9.

As a non-volatile computer-readable storage medium, the memory 120 may be configured to store a non-volatile software program, a non-volatile computer-executable program and a module, for example, program instructions corresponding to the obstacle avoidance method for UAV landing and the modules (for example, the obtaining module 200, the determining module 300 and the control module 400) corresponding to the obstacle avoidance apparatus for UAV landing in the foregoing embodiments of the present invention.

The processor 110 executes various functional applications and data processing of the obstacle avoidance method for UAV landing by executing the non-volatile software program, the instructions and the modules stored in the memory 120, that is, implements the obstacle avoidance method for UAV landing in the foregoing method embodiment and the functions of the modules of the foregoing apparatus embodiment.

The memory 120 may include a program storage area and a data storage area. The program storage area may store an operating system and an application program that is required by at least one function. The data storage area may store data created according to use of the obstacle avoidance apparatus for UAV landing and the like.

The data storage area further stores preset data, including a first preset threshold, a second preset threshold, a preset distance and the like.

In addition, the memory 120 may include a high speed random access memory (RAM), and may also include a non-volatile memory such as at least one magnetic disk storage device, a flash memory or another non-volatile solid-state storage device. In some embodiments, the memory 120 optionally includes memories remotely disposed relative to the processor 110, and these remote memories may be connected to the processor 110 through a network. Examples of the network include, but are not limited to, the Internet, an intranet, a local area network, a mobile communication network, and a combination thereof.

The program instructions and one or more modules are stored in the memory 120, which, when executed by the one or more processors 110, perform steps of the obstacle avoidance method for UAV landing in any of the foregoing method embodiments, or implement the functions of the modules of the obstacle avoidance apparatus for UAV landing in any of the foregoing apparatus embodiments.

For the foregoing product, the method provided in the embodiments of the present invention may be performed, and the corresponding functional modules for performing the method and beneficial effects thereof are provided. For technical details not described in detail in this embodiment, reference may be made to the method provided in the foregoing embodiments of the present invention.

An embodiment of the present invention further provides a non-volatile computer-readable storage medium, storing computer-executable instructions. The computer-executable instructions, when executed by one or more processors such as the processor 110 in FIG. 9, may cause a computer to perform steps of the obstacle avoidance method for UAV landing in any of the foregoing method embodiments, or implement the functions of the modules of the obstacle avoidance apparatus for UAV landing in any of the foregoing apparatus embodiments.

An embodiment of the present invention further provides a computer program product, including a computer program stored on a non-volatile computer-readable storage medium. The computer program includes program instructions, which, when executed by one or more processors such as one processor 110 in FIG. 9, may cause a computer to perform steps of the obstacle avoidance method for UAV landing in any of the foregoing method embodiments, or implement the functions of the modules of the obstacle avoidance apparatus for UAV landing in any of the foregoing apparatus embodiments.

The described apparatus embodiment is merely an example. The modules described as separate parts may or may not be physically separated, and parts displayed as modules may or may not be physical units, may be located in one position, or may be distributed on a plurality of network units. Some or all of the modules may be selected according to actual requirements to implement the objectives of the solutions of the embodiments.

Through the description of the foregoing embodiments, a person skilled in the art may clearly understand that the embodiments may be implemented by software in combination with a universal hardware platform, and may certainly be implemented by hardware. A person of ordinary skill in the art may understand that all or some of the processes of the methods in the foregoing embodiments may be implemented by a computer program instructing relevant hardware. The program may be stored in a computer-readable storage medium. During execution of the program, processes of the foregoing method embodiments may be included. The foregoing storage medium may be a magnetic disk, an optical disc, a read-only memory (ROM), a RAM or the like.

The foregoing descriptions are embodiments of the present invention, and the protection scope of the present invention is not limited thereto. All equivalent structure or process changes made according to the content of this specification and accompanying drawings in the present invention or by directly or indirectly applying the present invention in other related technical fields shall fall within the protection scope of the present invention.

Finally, it should be noted that the foregoing embodiments are merely intended for describing the technical solutions of the present invention rather than limiting the present invention. Under the ideas of the present invention, the technical features in the foregoing embodiments or different embodiments may also be combined, the steps may be performed in any order, many other changes of different aspects of the present invention also exist as described above, and these changes are not provided in detail for simplicity. Although the present invention is described in detail with reference to the foregoing embodiments, a person of ordinary skill in the art should understand that modifications may be still made to the technical solutions described in the foregoing embodiments or equivalent replacements may be made to some technical features thereof, as long as such modifications or replacements do not make the essence of corresponding technical solutions depart from the scope of the technical solutions of the embodiments of the present invention.

What is claimed is:

1. An obstacle avoidance method for unmanned aerial vehicle (UAV) landing, comprising:
obtaining a point cloud distribution map of a to-be-landed zone;
determining a safe zone in the to-be-landed zone according to the point cloud distribution map;
determining a target position in the safe zone; and
controlling the UAV to move to the target position, to enable the UAV to be away from an obstacle in the to-be-landed zone.

2. The method according to claim 1, wherein the obtaining a point cloud distribution map of a to-be-landed zone comprises:
obtaining the point cloud distribution map of the to-be-landed zone through a depth sensor of the UAV.

3. The method according to claim 2, wherein the obtaining the point cloud distribution map of the to-be-landed zone through a depth sensor of the UAV comprises:
obtaining point cloud data of the to-be-landed zone through the depth sensor; and
projecting the point cloud data to a two-dimensional plane to obtain the point cloud distribution map.

4. The method according to claim 1, wherein the determining a target position in the safe zone comprises:
determining a center of gravity position of the safe zone; and
determining the center of gravity position of the safe zone as the target position.

5. The method according to claim 4, wherein the determining a center of gravity position of the safe zone comprises:
extracting coordinates of each point cloud in the safe zone; and
determining, according to the coordinates of each point cloud, the center of gravity position of the safe zone as:
$$X = \frac{{\sum }_{i = 1}^{n} X i}{n} and Y = \frac{{\sum }_{i = 1}^{n} Yi}{n} ,$$
n being a total quantity of point clouds in the safe zone, Xi being a horizontal coordinate of an i^{th} point cloud in the safe zone, Yi being a vertical coordinate of the i^{th} point cloud in the safe zone, X being a horizontal coordinate of the center of gravity position and Y being a vertical coordinate of the center of gravity position.

6. The method according to claim 1, wherein the controlling the UAV to move to the target position comprises:
determining a direction in which the target position is located as a first target direction; and
controlling the UAV to move in the first target direction to the target position.

7. The method according to claim 6, wherein before the controlling the UAV to move in the first target direction to the target position, the method further comprises:
determining whether there is an obstacle in the first target direction, and controlling the UAV to move in the first target direction to the target position if there is no obstacle.

8. The method according to claim 7, wherein whether there is an obstacle in the first target direction is determined through a perception sensor.

9. The method according to claim 8, wherein the perception sensor is a one-way perception sensor, and the method further comprises:
controlling a perception direction of the one-way perception sensor to be consistent with the first target direction.

10. The method according to claim 1, wherein before the controlling the UAV to move to the target position, the method further comprises:
determining a center position of the to-be-landed zone; and
determining whether the target position is consistent with the center position of the to-be-landed zone, and redetermining a target position if the target position is consistent with the center position of the to-be-landed zone.

11. The method according to claim 10, wherein the redetermining a target position comprises:
determining a direction in which there is no obstacle in the to-be-landed zone as a second target direction; and
determining a target position in the safe zone after controlling the UAV to move in the second target direction by a preset distance.

12. The method according to claim 1, wherein after the controlling the UAV to move to the target position, the method further comprises:
determining whether there is a risky zone in a to-be-landed zone centered around the target position, and
controlling the UAV to land if there is no risky zone; or
determining a target position in the to-be-landed zone centered around the target position if there is a risky zone.

13. The method according to claim 12, further comprising:
determining whether a quantity of times of determining a target position in the to-be-landed zone centered around the target position exceeds a first preset threshold, and controlling the UAV to issue a warning and/or controlling the UAV to stop landing if the first preset threshold is exceeded.

14. The method according to claim 1, wherein before the determining a target position in the safe zone, the method further comprises:
determining a ratio R1 of a quantity of point clouds in the safe zone to a quantity of point clouds in the to-be-landed zone; and
determining whether R1 is greater than a second preset threshold, and determining a target position in the safe zone if R1 is greater than the second preset threshold.

15. An obstacle avoidance apparatus for unmanned aerial vehicle (UAV) landing, comprising:
a processor, configured to:
obtain a point cloud distribution map of a to-be-landed zone;
determine a safe zone in the to-be-landed zone according to the point cloud distribution map;
determine a target position in the safe zone; and
control the UAV to move to the target position, to enable the UAV to be away from an obstacle in the to-be-landed zone.

16. The apparatus according to claim 15, wherein the processor obtains the point cloud distribution map of the to-be-landed zone through a depth sensor of the UAV.

17. The apparatus according to claim 16, wherein the processor is specifically configured to:
obtain point cloud data of the to-be-landed zone through the depth sensor; and
project the point cloud data to a two-dimensional plane to obtain the point cloud distribution map.

18. The apparatus according to claim 15, wherein the processor is configured to:
determine a center of gravity position of the safe zone; and
determine the center of gravity position of the safe zone as the target position.

19. The apparatus according to claim 18, wherein the processor is further configured to:
extract coordinates of each point cloud in the safe zone; and
determine, according to the coordinates of each point cloud, the center of gravity position of the safe zone as:
$$X = \frac{{\sum }_{i = 1}^{n} X i}{n} and Y = \frac{{\sum }_{i = 1}^{n} Yi}{n} ,$$
n being a total quantity of point clouds in the safe zone, Xi being a horizontal coordinate of an i^{th} point cloud in the safe zone, Yi being a vertical coordinate of the i^{th} point cloud in the safe zone, X being a horizontal coordinate of the center of gravity position and Y being a vertical coordinate of the center of gravity position.

20. The apparatus according to claim 15, wherein the processor is configured to:
determine a direction in which the target position is located as a first target direction; and
control the UAV to move in the first target direction to the target position.

21. The apparatus according to claim 20, wherein the processor is further configured to:
determine whether there is an obstacle in the first target direction, and control the UAV to move in the first target direction to the target position if there is no obstacle.

22. The apparatus according to claim 21, wherein the processor determines whether there is an obstacle in the first target direction through a perception sensor.

23. The apparatus according to claim 22, wherein the perception sensor is a one-way perception sensor, and the processor is further configured to:
control a perception direction of the one-way perception sensor to be consistent with the first target direction.

24. The apparatus according to claim 15, wherein the processor is further configured to:
determine a center position of the to-be-landed zone; and
determine whether the target position is consistent with the center position of the to-be-landed zone, and redetermine a target position if the target position is consistent with the center position of the to-be-landed zone.

25. The apparatus according to claim 24, wherein the processor is further configured to:
determine a direction in which there is no obstacle in the to-be-landed zone as a second target direction; and
determine a target position in the safe zone after controlling the UAV to move in the second target direction by a preset distance.

26. The apparatus according to claim 15, wherein the processor is further configured to:
determine whether there is a risky zone in a to-be-landed zone centered around the target position, and
control the UAV to land if there is no risky zone; or
determine a target position in the to-be-landed zone centered around the target position if there is a risky zone.

27. The apparatus according to claim 26, wherein the processor is further configured to:
determine whether a quantity of times of determining a target position in the to-be-landed zone centered around the target position exceeds a first preset threshold, and control the UAV to issue a warning and/or control the UAV to stop landing if the first preset threshold is exceeded.

28. The apparatus according to claim 15, wherein the processor is further configured to:
determine a ratio R1 of a quantity of point clouds in the safe zone to a quantity of point clouds in the to-be-landed zone; and
determine whether R1 is greater than a second preset threshold, and determine a target position in the safe zone if R1 is greater than the second preset threshold.

29. An unmanned aerial vehicle (UAV), comprising:
a body;
arms connected to the body;
power apparatuses disposed on the arms;
at least one processor disposed in the body; and
a memory communicatively connected to the at least one processor, the memory storing instructions executable by the at least one processor, the instructions being executed by the at least one processor, to enable the at least one processor to perform the following operations:
obtaining a point cloud distribution map of a to-be-landed zone;
determining a safe zone in the to-be-landed zone according to the point cloud distribution map;
determining a target position in the safe zone; and
controlling the UAV to move to the target position, to enable the UAV to be away from an obstacle in the to-be-landed zone.

30. A non-volatile computer-readable storage medium, storing computer-executable instructions used for causing an unmanned aerial vehicle (UAV) to perform the following operations:
obtaining a point cloud distribution map of a to-be-landed zone;
determining a safe zone in the to-be-landed zone according to the point cloud distribution map;
determining a target position in the safe zone; and
controlling the UAV to move to the target position, to enable the UAV to be away from an obstacle in the to-be-landed zone.
